(19) United States
(12) Patent Application Publication
(10) Pub. No.: US 2024/0127706 A1
(43) Pub. Date: Apr. 18, 2024

(54) Breaching Door Trainer

(71) Applicant: Ruhl, Inc., Spring Lake, NC (US)

(72) Inventor: Andrew S. Ruhland, Spring Lake, NC (US)

(21) Appl. No.: 17/968,652

(22) Filed: Oct. 18, 2022

(51) Int. Cl. G09B 9/00; G09B 19/00

(52) U.S. Cl. CPC G09B 9/00; G09B 19/00

(57) ABSTRACT

Door breach training systems that utilize a non-consumable detent system for releasably holding the door closed for repeated breaching episodes. The door breach training system includes a doorframe, a door pivotally mounted to the doorframe, and one or more detent systems interconnecting the door and doorframe and configured to releasably maintain the door closed so as to be pivotally aligned with the doorframe. The detent systems are configured to be reusable for a plurality of breaching events without replacing any components thereof. The detent systems include a first portion mounted to the doorframe, and a second portion mounted to the door and configured to releasably engage the first portion; and an elastic element that urges the first and second portions into engagement.

The present disclosure relates generally to breaching door trainers and, more particularly, to a breaching door trainer that utilizes a non-consumable detent system for releasably holding the door closed for repeated breaching episodes, optionally with adjustable holding force.

### BACKGROUND

There are numerous times where law enforcement or others may need to breach a doorway, such as to get emergency access for a rescue operation. As can be appreciated, training on breaching techniques is important to securing a good outcome. Therefore, a variety of breach training systems have been proposed to provide breach training. However, many of these breach training systems employ components that are designed to be broken or otherwise consumed and/or employ mechanisms that are difficult to reset and/or have other features that prevent simulation of some breaching situations. Thus, prior art breach training systems may be difficult to use in some situations, particularly situations requiring repeated breaching events.

Therefore, there remains a need for alternative breach training systems, preferably a breaching door trainer that utilizes a non-consumable detent system for releasably holding the door closed for repeated breaching episodes, optionally with adjustable holding force.

### SUMMARY

The present disclosure relates generally to door breach training systems that utilize a non-consumable detent system for releasably holding the door closed for repeated breaching episodes. The door breach training system includes a doorframe, a door pivotally mounted to the doorframe; and one or more detent systems interconnecting the door and doorframe and configured to releasably maintain the door closed so as to be pivotally aligned with the doorframe. The detent systems are configured to be reusable for a plurality of breaching events without replacing any components thereof. The detent systems include a first portion mounted to the doorframe, and a second portion mounted to the door and configured to releasably engage the first portion; and an elastic element that urges the first and second portions into engagement.

In one aspect, the present disclosure relates to door breach training system. The door breach training system includes a doorframe; a door pivotally mounted to the doorframe; and one or more detent systems interconnecting the door and doorframe and configured to releasably maintain the door closed so as to be pivotally aligned with the doorframe. The detent systems are configured to be reusable for a plurality of breaching events without replacing any components thereof. The detent systems include a first portion mounted to the doorframe; a second portion mounted to the door and configured to releasably engage the first portion; and an elastic element that urges the first and second portions into engagement. The detent systems are configured to have an adjustable static contact force when the first and second portions are statically abutting, wherein the static contact force is infinitely adjustable. The door breach training system may optionally include a pair of support leg assemblies configured to support the doorframe in a freestanding condition, each support leg assembly comprising at least two legs, wherein the legs are connected to the doorframe so as to be deployable at a plurality of angles relative to the doorframe. In some embodiments, the detent systems each include a visual indicator to indicate that first and second portions are abutting. In some embodiments, each second portion comprises a mounting portion having threads; a piston slidably mounted to the mounting portion and having a tip; an elastic element captured between the mounting portion and the tip; wherein the elastic element biases the tip away from the mounting portion; wherein the retention force is adjustable by tightening and/or loosening of the mounting portion via the threads. In some embodiments, the first portion is both insertable into and removable from the doorframe without accessing the outer perimeter of the doorframe.

In another aspect, the present disclosure relates to a door breach training system. The door breach training system includes a doorframe having an outer perimeter and an inner perimeter; a door pivotally mounted to the doorframe; a plurality of detent systems interconnecting the door and doorframe and configured to releasably maintain the door closed so as to be pivotally aligned with the doorframe. The detent systems are configured to be reusable for a plurality of breaching events without replacing any components thereof. The detent systems each comprise a first portion mounted to the doorframe; a second portion mounted to the door and configured to releasably engage the first portion; and an elastic element that urges the first and second portions into engagement. The first portion is both insertable into and removable from the doorframe without accessing the outer perimeter of the doorframe. In some embodiments, the first and second portions are urged toward engagement by an elastic element forming a portion of the second portion. In some embodiments, the first portion is configured such that the body extends inwardly beyond the inner perimeter when the first portion is secured in the doorframe by the retainer.

Other aspects of the components, the door breaching system, and related methods are also evident from the following description and corresponding drawings.

### BRIEF DESCRIPTION OF THE DRAWINGS

FIG. 1 is a rear perspective view of a door breach training system according to an exemplary embodiment, with the door closed.

FIG. 2 shows a rear view of the door breach training system of FIG. 1

FIG. 3 shows a doorframe with an optional reinforcing channel.

FIG. 4 shows a door with some portions of detent systems mounted thereto.

FIG. 5 shows a partially exploded partial cutaway of a portion of the door breach training system of FIG. 1, showing an exemplary detent system mounted in a door and doorframe.

FIG. 6 shows first and second portions of the detent system of FIG. 5.

FIG. 7 shows a perspective view of a first portion of the detent system of FIG. 6.

FIG. 8 shows a cross-sectional view of the first portion of FIG. 7.

FIG. 9 shows a side view of a second portion of the detent system of FIG. 6.

FIG. 10 shows an exploded view of the second portion of FIG. 9.

FIGS. 11A-C show a cross-sectional view of detent system of FIG. 6 at stages of the door being breached.

FIG. 12 shows a perspective view of an optional support leg assembly.

FIG. 13 shows an exploded view of an optional strikeplate and related components.

FIG. 14 shows an alternative detent system with a slider, in an engaged state.

FIG. 15 shows the detent system of FIG. 14 with the slider pried back to disengage the first and second portions of the detent system.

FIG. 16 shows rear perspective view of the door breach training system of FIG. 1, with the door opened.

### DETAILED DESCRIPTION

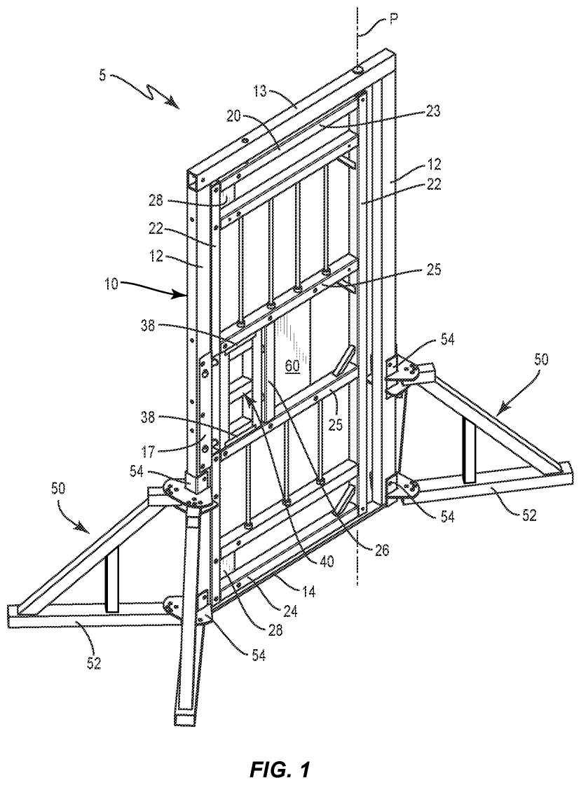

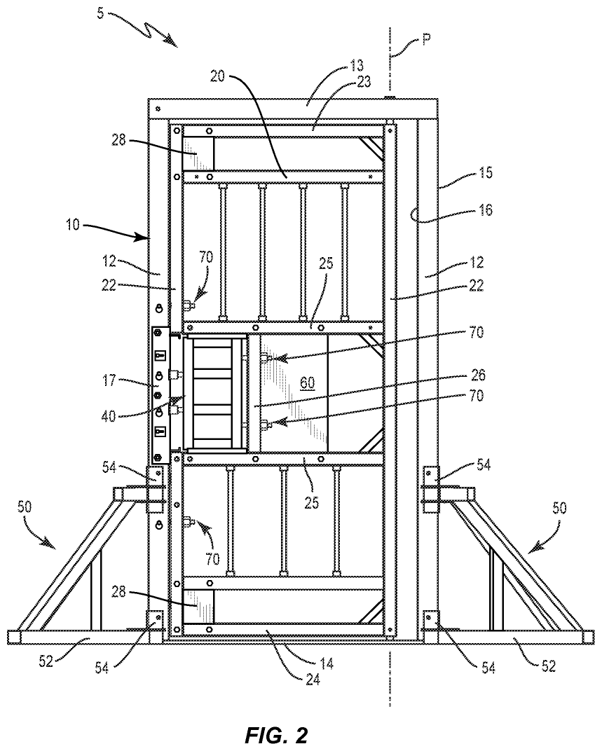

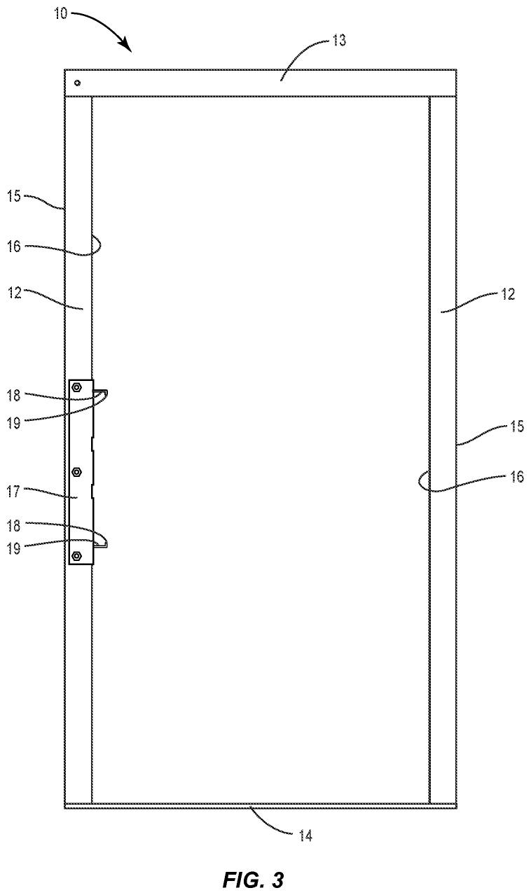

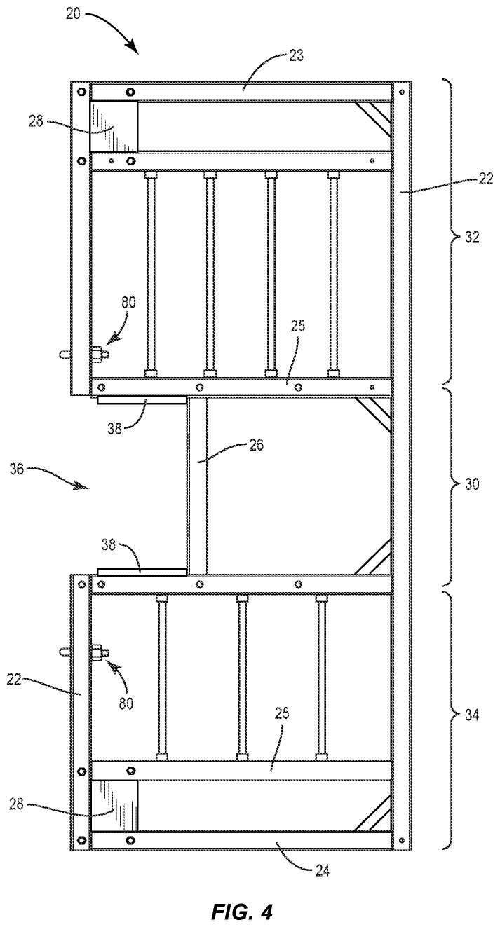

FIG. 1 illustrates a exemplary door breach training system 5. The door breach training system 5 includes a doorframe 10, a door 20 configured to be pivotally mounted to the doorframe 10, and one of more detent systems 70. The doorframe 10 is advantageously generally rectangular, with a pair of side posts 12, a top rail 13, and an optional bottom rail 14. The doorframe 10 has an outer perimeter 15 that is outwardly oriented, and an inner perimeter 16 that is inwardly oriented. The doorframe 10 is intended to be upright in use. To facilitate this, optional support leg assemblies 50 may be used on respective lateral sides of the doorframe 10. The support leg assemblies 50 each include a pair of outwardly extending legs 52, and are advantageously removably mounted to the lower portion of the doorframe 10, such as by suitable bolts/pins and brackets 54. In some embodiments, the legs 52 of the support leg assemblies 50 are pivotally connected to the doorframe 10, so that at least some of the legs 52, and advantageously all of the legs 52, can be pivoted with respect to the doorframe 10. For example, the legs may be pivotally mounted to brackets 54 that connect the legs 52 to the doorframe 10, and these brackets 54 may include a plurality of holes arrayed in an arc, which allow the legs 52 to be held in a desired angular position by bolts/pins. The allowed angular positions advantageously include a position parallel to the doorframe 10, a position perpendicular to the doorframe 10, and one or more intermediate positions between those two positions. The mounting brackets 54 may be secured to the doorframe 10 by suitable fasteners, such as bolts or locking pins, and are advantageously removable for shipment/storage and/or when mounting the doorframe 10 in a breach training house.

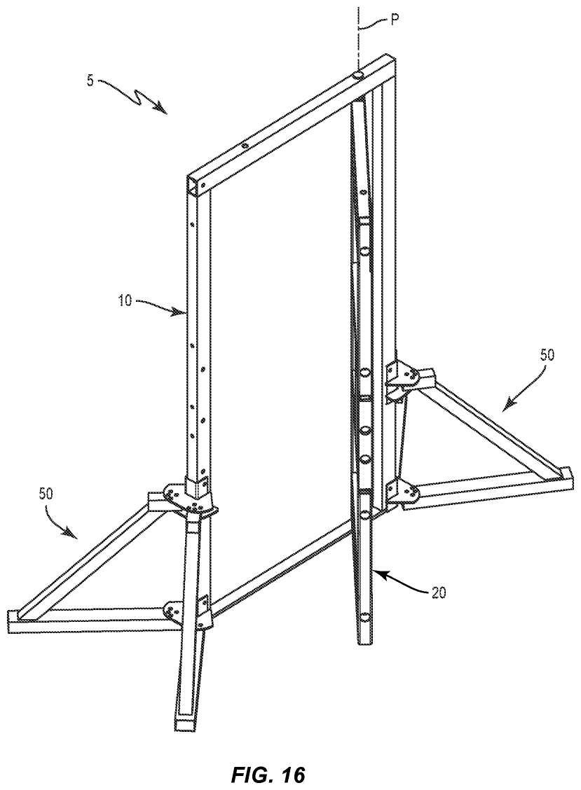

The door 20 is pivotally mounted to the doorframe 10 so that the door 20 can move between a closed position where the door 20 is aligned with the doorframe 10 (see FIG. 1), and an open position where the door 20 is pivoted about pivot axis P so as to be angled with respect to doorframe 10 (see FIG. 16). The door 20 is likewise advantageously generally rectangular, with side posts 22, a top rail 23, and a bottom rail 24. In addition, the illustrated door 20 also includes two or more horizontal mounting bars 25 for mounting an optional exteriorly mounted removable strikeplate 60 via suitable bolts, and for helping define a recess 36 for a slider 40 (discussed further below). The illustrated door 20 further includes an optional vertical mounting bar 26 for mounting a portion of one or more detent systems 70, as will be described further below. The door 20 may optionally include additional upper and/or lower fixed strikeplates 28, and/or various attachment mechanisms for attaching bars, windows, or the like. For ease of reference, the portion of the door 20 between the two horizontal mounting bars 25 may be referred to as the central zone 30, and generally corresponds to where a doorknob and/or deadbolt is typically located in a conventional home door. An upper zone 32 is located above the central zone 30, and a lower zone 34 is located below the central zone 30.

The optional exteriorly mounted removable strikeplate 60 advantageously takes the form of a simple rectangular plate of suitable strength, although other shapes may be employed. The strikeplate 60 typically includes four mounting holes 62, one at each corner. Optionally, a plurality of cushion standoffs 64 are located on the side of the strikeplate 60 facing the door 20, so as to be disposed between the door 20 and the strikeplate 60. Thus, the strikeplate 60 does not contact the door 20. Suitable fasteners (e.g., bolts and nuts) are used to secure the strikeplate 60 to the horizontal mounting bars 25 of door 20.

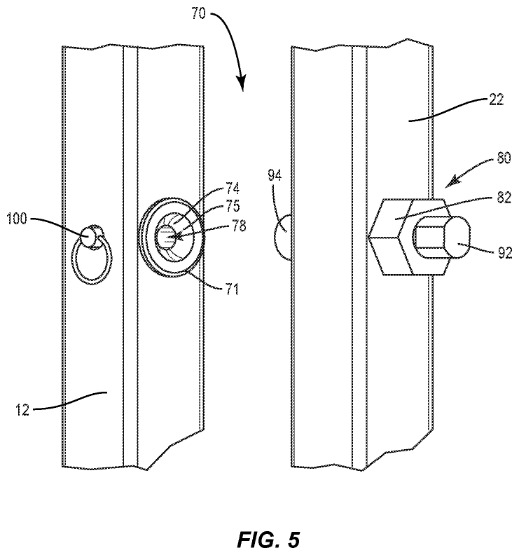

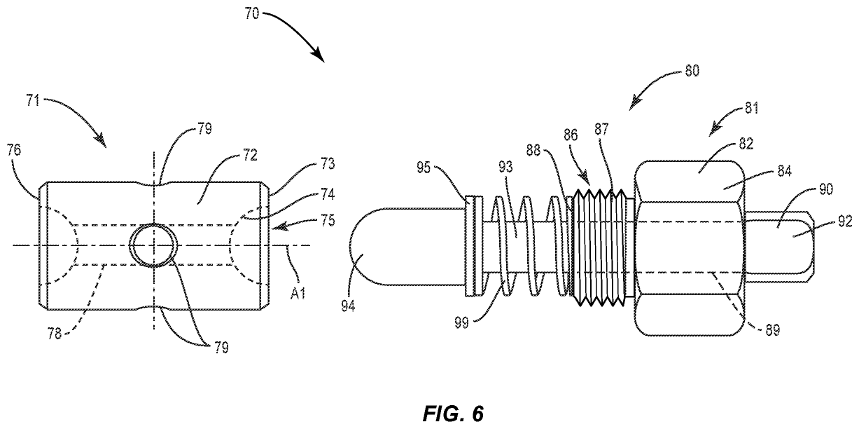

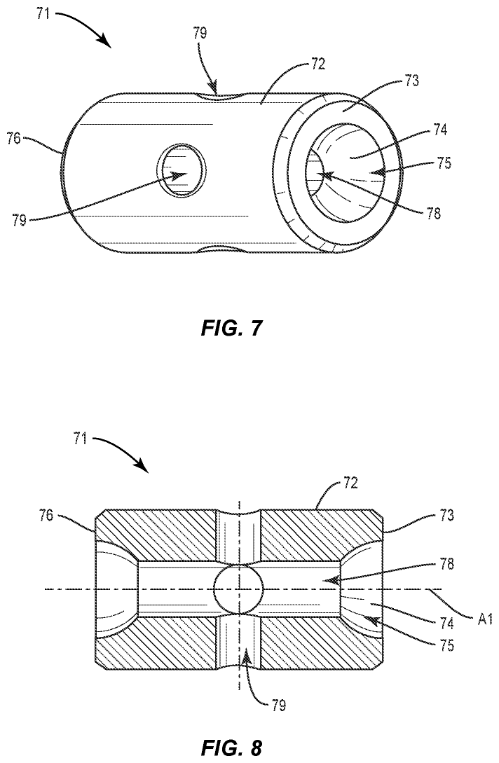

One or more detent systems 70 releasably interconnect the door 20 and the doorframe 10, and are configured to releasably maintain the door 20 closed so as to be pivotally aligned with the doorframe 10. The detent system 70 includes a first portion 71 mounted to the doorframe 10, and a second portion 80 mounted to the door 20 and configured to releasably engage the first portion 71. An example of one embodiment of a detent system 70 is shown in FIGS. 5-110. The first portion 71 includes a generally cylindrical body 72 having a front face 73 and a rear face 76. See FIGS. 6-8. The front face 73 is generally flat and oriented perpendicular to the longitudinal axis A1 of the body 72. An optional recessed area 75 sometimes referred to herein as a dimple is centered relative to the front face 73. The dimple 75 includes a bearing face 74 that faces forward for engagement with the second portion 80, as described further below. The forward-most portion of the bearing face 74 is optionally recessed relative to the front face 73, with an optional chamfer where the perimeter of the dimple 75 meets the front face 73. The body 72 optionally includes a longitudinal passage 78, and/or one or more optional cross passages 79, for receiving a locking pin for securing the first portion 71 to the doorframe 10. In some embodiments, the first portion 71 is double-ended in that there are dimples 75 and/or bearing faces 74 on each longitudinal end; in other embodiments, the first portion 71 is single-ended.

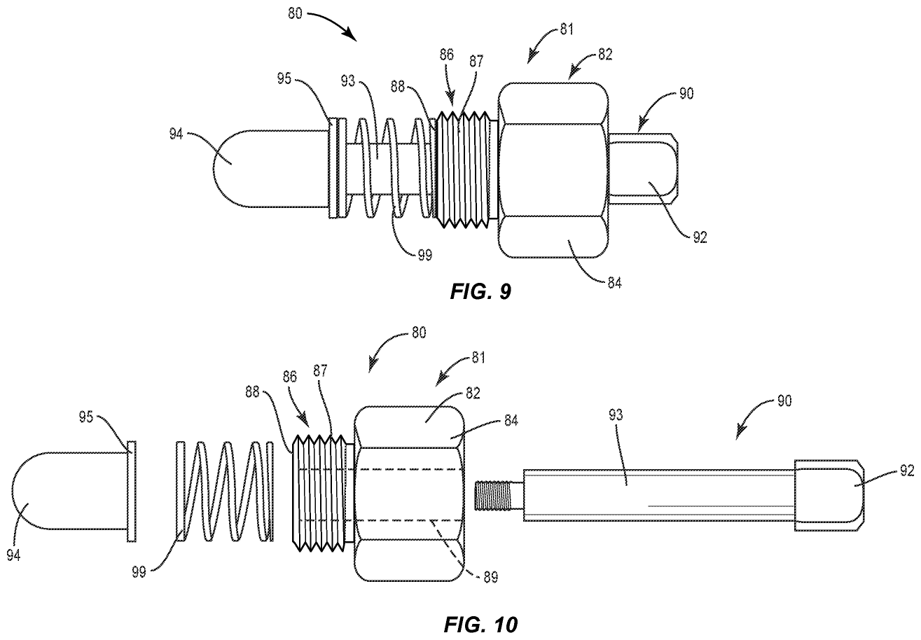

The second portion 80 of the detent system 70 of FIG. 5 includes an assembly 81 of a mounting portion 82, a piston 90, and an elastic element 99. See FIGS. 6, 9-10. The mounting portion 82 includes a faceted rear section 84 and a forwardly protruding nose 86 having threads 87 thereon, and a bearing face 88. The rear section 84 is faceted to facilitate engagement with a suitable tool for threading the nose 86 into the door 20 so as to mount to the second portion 80 to the door 20. The piston 90 is slidable relative to the mounting portion 82 and includes a distal tail 92, an intermediate portion 93, and a proximal tip 94. The intermediate portion 93 extends through a suitable passage 89 in the mounting portion 82, such that the tail 92 and the tip 94 are disposed on opposite sides of the mounting portion 82. The tip 94 advantageously includes a flange 95. The elastic element 99, sometimes referred to as spring 99, is captured between the mounting portion 82 and the tip 94. The spring 99 is disposed so as to urge the tip 94 away from the mounting portion 82 when compressed. The elastic element 99 advantageously presses against the bearing face 88 and tip flange 95 when compressed. The elastic element 99 may be referred to as the spring 99 in the description herein, but it should be understood that any suitable form of elastic element 99 may be used. Note that, in some embodiments, the threaded engagement of the tip 94 and the intermediate portion 93 is beyond the spring 99 so that spring 99 does not overlap the threads of the threaded connection.

The first portion 71 of the detent system 70 is secured to the doorframe's side post 12, on the side of the doorframe 10 opposite the pivot axis P of the door 20, in a suitable location. By way of example, a detent system 70 may be located near the top corner of the door 20, and/or about a ⅓ of the way down the door 20, and/or about ⅔ of the way down the door 20, and/or near the lower corner of the door 20. The first portion 71 may be inserted into the doorframe 10 into a suitable reinforcing tube if desired, and secured to the doorframe 10 by a suitable removable locking pin inserted through the cross passages 79, or by a bolts or the like. The longitudinal passage 78 is advantageously oriented perpendicular the side post 12, with the front face 73 facing the door 20 when the door 20 is closed. The front face 73 of the first portion 71 may be generally flush with the inner perimeter 16 of the door 20 frame, or may optionally protrude inwardly toward the door 20. If the first portion 71 needs to be replaced, the locking pin is removed, and the first portion 71 is pulled from the doorframe 10, such as by inserting the locking pin into the longitudinal passage 78, where a ball detent on the locking pin can engage a cross passage 79, and then pulling the locking pin. A replacement first portion 71 can then be secured to the doorframe 10 and/or the first portion 71 can be reversed and reinstalled so that the rear face 76 faces toward the door 20. Note that the addition and removal of the first portion 71 to/from the doorframe 10 is accomplished from the direction of the inner perimeter 16 of the doorframe 10, and no access to the outer perimeter 15 of the doorframe 10 is needed.

The second portion 80 of the detent system 70 is secured to the side post 22 of the door 20, on the side of the door 20 opposite the pivot axis P, in a location corresponding to the corresponding first portion 71. The second portion 80 may be inserted into the door 20 into a suitable reinforcing tube if desired, and secured to the door 20 by a engagement of the threads 87 with corresponding threads on the door 20 and/or reinforcing tube. The second portion 80 is positioned such that the tip 94 of the piston 90 extends outward from the door 20 toward the doorframe 10, while the rear section of the mounting portion 82 extends inward from the opposite side of the door side post 22. The tail 92 of the piston 90 extends inward from the rear section 84. The spring 99 is advantageously disposed internal to the door side post 22.

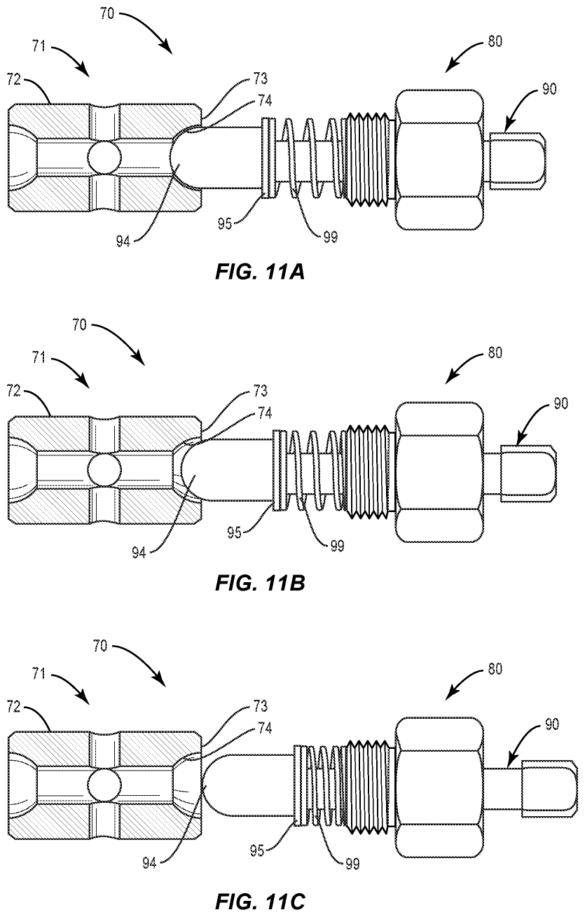

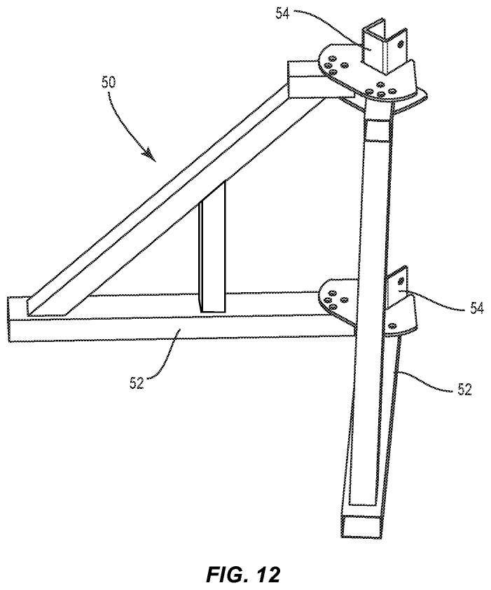

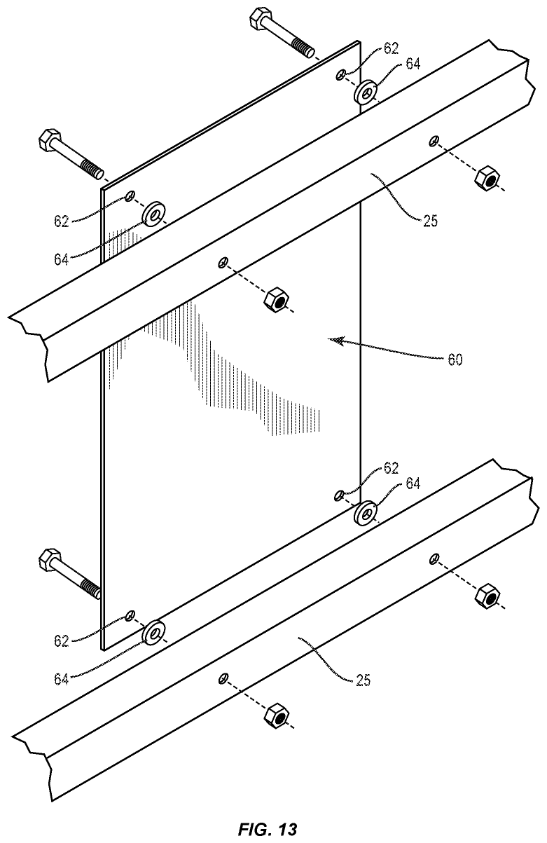

With the detent system 70 installed, and the door 20 closed, the first portion 71 presses against the second portion 80 to releasably maintain the door 20 closed so as to be pivotally aligned with the doorframe 10. As shown in FIG. 11A, the tip 94 of the piston 90 of the second portion 80 is pressed forward by the spring 99 and presses against the bearing face 74 of the first portion 71. The amount of force that the tip 94 presses against the first portion 71, when the door 20 is not being forced open, may be referred to as the static contact force. The amount of the static contact force is governed by the amount of compression of the spring 99, and the spring constant of spring 99. The amount of compression of the spring 99 may be adjusted by turning the rear section 84 to adjust the amount of thread engagement, and therefore the distance between the bearing face 88 on the nose 86 of the mounting portion 82 and the bearing face 74 of the first portion 71. Thus, rotating the mounting portion 82 to increase the threaded engagement moves the mounting portion 82 closer to the doorframe 10, and thereby increases compression of the spring 99, thereby increasing the static contact force. Conversely, rotating the mounting portion 82 to decrease the threaded engagement moves the mounting portion 82 away from to the doorframe 10, and thereby decreases compression of the spring 99, thereby decreasing the static contact force. The amount of static contact force is infinitely adjustable. For example, the amount of static contact force with a given single detent system 70 may be set to any non-zero value in the range of one to about sixty pounds depending on the position of the mounting portion 82. As can be appreciated, the range is determined by the spring 99 and the allowed range of threaded engagement of the mounting portion 82. Note that providing a longer amount of threading on the nose 86 allows for a greater range of adjustment of the static contact force. Due to their configuration, the present detent systems 70 allow for infinite adjustment of static contact force when the first and second portions 71,80 of the detent systems 70 are statically abutting, which is believed to be not possible with the prior art.

In the embodiment of FIGS. 5-6, 9-10, the second portion 80 includes a piston 90 that extends both forward of and rearward of the mounting portion 82. The rearward extension includes the tail 92. The tail 92 is larger than the passage 89 such that the tail 92 is configured to be in contact with the inner side of the rear section 84 of the mounting portion 82 when the piston 90 is fully protruding forward from the mounting portion 82. Thus, the tail 92 advantageously acts as a stop for the piston 90 for movement in the direction of bias from the spring 99, with the tail 92 abutting the mounting portion 82 before the tip 94 engages the bearing face 74. The tail 92 is advantageously formed integrally with the intermediate portion 93 of the piston 90. In some embodiments, the tail 92 functions as an indicator that that the first and second portions 71,80 are abutting and optionally an indication of the amount of static contact force. As the mounting portion 82 is tightened into position, the tip 94 is pressed against the bearing face 74, which causes the piston 90 to displace rearward relative to the mounting portion 82 against the bias of the spring 99. This rearward displacement of the piston 90 causes the tail 92 to displace away from the mounting portion 82. Thus, the presence of a gap between the tail 92 and the mounting portion 82 provides an indication that the tip 94 is being pressed against the bearing face 74. In some embodiments, the piston 90 may include line(s) or color(s) or other indicia that are hidden/exposed as the piston 90 is displaced relative to the mounting portion 82, to indicate when the mounting portion 82 has been threaded the appropriate amount.

The amount of static contact force can also be varied by replacing the spring 99 with a spring 99 having a different spring constant in some embodiments of the second portion 80. To do so, the second portion 80 is dismounted from the door 20, and the tip 94 is removed from the remainder of the piston 90 (such as by unscrewing the tip 94). The existing spring 99 is then removed and replaced with a replacement spring 99 having a different spring constant. In some embodiments, springs having different spring constants are color coded for easy identification. The tip 94 is then reattached, and the second portion 80 remounted to the door 20. As similar approach may be taken to replace a broken spring 99 if needed. Changing out the spring 99 to be one with a different spring constant allows the range of the static contact force with a given single detent system 70 to be changed, for example such that the static contact force can be set to any non-zero value in the range of one to about ninety-five pounds (e.g., with a blue color coded spring), or one to about six hundred twenty five pounds (e.g., with a yellow color coded spring), rather than one to about sixty pounds (e.g., with a green color coded spring).

The static contact force provides some resistance to opening the door 20 because the detent system(s) 70 inhibit pivoting the door 20 relative to the doorframe 10. This resistance can be overcome by prying or otherwise forcing the door 20 open. In doing so, the tip 94, being rounded, slides against the rounded bearing face 74 of the first portion 71 when sufficient force is applied. This sliding allows the tip 94 to be displaced out of engagement with the first portion 71, thereby allowing the door 20 to open (assuming there are no other restrictions to opening the door 20). The forcing open of the door 20 against the retention force of the detent system 70 is called a breaching event. As an example of the changes to the detent system during progression of a breaching event, see FIGS. 11A-11C. FIG. 11A shows the detent system 70 before a prying force is applied. FIG. 11B shows the detent system 70 as a dynamic prying force is applied to overcome the static contact force, thus breaking contact between tip 94 and bearing surface 74. FIG. 11C shows the detent system 70 as more dynamic prying force is applied such that the tip 94 is displaced beyond the front face 73 thereby releasing the door 20 to swing open. The spring 99 is somewhat compressed in FIG. 11A, more compressed in FIG. 11B, and further compressed in FIG. 11C.

Once the door 20 is opened, the detent system 70 may be reset by pulling the door 20 closed to reseat the tip 94 against the bearing face 74. This reset may be facilitated by backing the mounting portion 82 partially out of the door 20 to, in effect, “pull” the tip 94 backward away from the door 20, to provide suitable clearance. Once the first portion 71 and the second portion 80 are aligned again (corresponding to the door 20 being “closed” in pivoting alignment with the doorframe 10), the mounting portion 82 may be screwed back into the desired position so that the desired static contact force is achieved.

Note that the breaching of the door 20, which involves overcoming of the retention force of the detent system 70, is accomplished without consuming any components of the detent system 70. Thus, no portions of the detent system 70 are broken or consumed in the process of overcoming of the retention force of the detent system 70. This is in sharp contrast to most prior art breaching door systems that employ breakable dowels (or boards) that fundamentally have to be broken to release the door to open. The present detent system(s) 70 are instead reusable for a plurality of breaching events without replacing any components thereof, and may therefore be thought of as “non-consumable” in that the components connecting the door to the doorframe so as to inhibit opening of the door are not consumed in a single breaching event. Typically, no components of the detent system 70 will need to replaced for hundreds of breaching events or more, but some tips 94 and/or second portions 80 may become damaged after repeated use, and can be easily replaced.

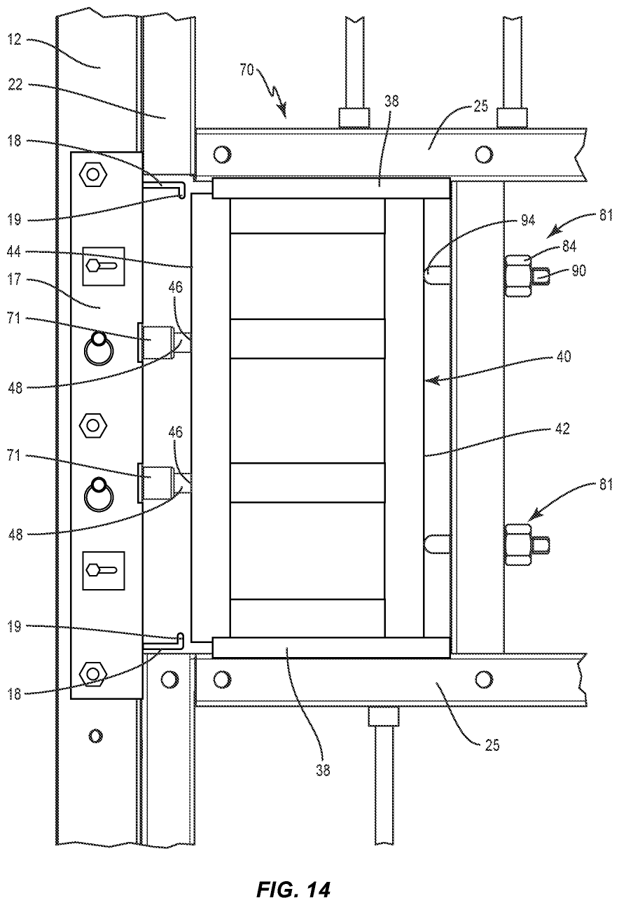

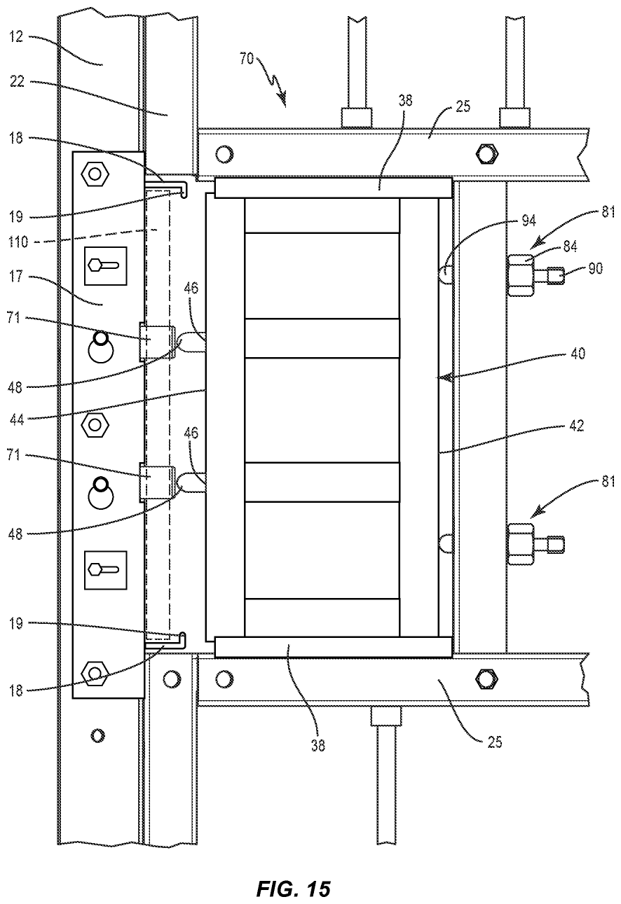

In some embodiments, a slider 40 is slidably mounted in the door 20. In an example, the slider 40 is a generally rectangular metal frame that is positioned in the door 20 and slides toward and away from the doorframe 10. See for example FIGS. 14-15. The slider 40 includes an inner face 42, facing the door 20, and an outer face 44, facing the doorframe 10. The outer face 44 includes one or more mounting holes for removably receiving a metal finger 48 that protrudes outward away from the slider's outer face 44 toward the doorframe 10. The tip of the finger 48 is advantageously rounded and shaped like the tip 94 of piston 90, and is intended to press against the bearing face 74 of a corresponding first portion 71 mounted to the doorframe 10. Alternatively, the finger(s) 48 are permanently mounted so as to protrude from the slider's outer face 44 of the slider 40. One or more assemblies 81 of a mounting portion 82, piston 90, and spring 99, as generally described above, are removably mounted to the vertical mounting bar 26 of door 20. The tips 94 of the pistons 90 of the assemblies 81 push against the inner face 42 of the slider 40, and may be rounded or flat as is desired. This inner face 42 may optionally be reinforced in the zones of contact between the tips 94 and the inner face 42. The assemblies 81 apply a forward push to the slider 40, urging the slider 40 toward the doorframe 10. The slider 40, with its associated fingers 48, conceptually act as an extension of the assemblies 81. Thus, the combination of the assemblies 81 and the slider 40 form a version of a second portion 80 of a detent system 70. Thus, the combination of the one or more assemblies 81, the slider 40, and the one or more first portions 71 (mounted to the doorframe 10 in alignment with the fingers 48) form a detent system 70. This detent system 70 acts similar to the detent system 70 discussed above, with the fingers 48 engaging the second portions 80 and pressing against the bearing surfaces 74 to releasably interconnect the door 20 and doorframe 10 and releasably maintain the door 20 closed so as to be pivotally aligned with the doorframe 10.

In some embodiments, the second portion 80 of the detent system 70 may not include a sliding piston 90. Instead, such a second portion 80 includes an assembly 81 of a mounting portion 82, tip 94, and spring 99 as described above. The spring 99 is disposed in a suitable passage in the side post 22, and the flange 95 of the tip 94 is likewise disposed in the passage and acts as a tip retainer. The mounting portion 82, as it is tightened, pushes against the spring 99, which pushes the tip 94. Such an arrangement lacks the advantage of having the piston 90 available to pull the tip 94 backward when the mounting portion 82 is loosened (so as to, for example, provide clearance when closing the door 20 and resetting the detent system 70). For such configurations, it may be necessary to impact the tip 94 to move it backward if it is difficult to move. The lack of the piston 90 may also prevent the second portion 80 from having static contact force indicating function discussed above. Such configurations may be used in any location of the detent systems 70, as is desired.

In some embodiments, a channel 17 or the like is used to reinforce the side post 12 of the doorframe 10 in the central zone 30 across from the slider 40. This channel 17 may optionally be removably mounted to the side post 12. The channel 17 may optionally include flanges 18 that extend inwardly toward the door 20, and advantageously include stops 19 on the end thereof that optionally limit motion of the slider 40 toward the doorframe 10. Further, in some embodiments, an optional removable cushion 110 may be positioned between the slider and the doorframe 10 to simulate some flexion in a conventional doorframe 10 (see FIG. 15). The cushion may advantageously be held in position by the flanges 18 and stops 19 on the channel 17. Such cushion 100 should have suitable cutouts therein for allowing the first and second portions 71,80 of the detent system 70 to inter-engage and operate without interference.

The discussion above has generally be in the context of the dimple 75 being on the first portion 71, and the rounded tip 94 of the piston 90 or finger 48 being on the corresponding second portion 80. However, in some embodiments, this may be reversed in some or all of the detent systems 70 such that the dimple 75 (and bearing face 74) is associated with the second portion 80, and the rounded tip 94 is associated with the corresponding first portion 71.

In some embodiments, the door breaching system 5 may optionally include wheels (not show), advantageously removably mounted to the doorframe 10, to facilitate movement of the door breaching system 5. Such wheels should advantageously be removed when setting up the door breaching system 5 for a breaching event.

In some embodiments, a wooden insert may be used rather than a slider 40, with a doorknob and/or deadbolt lock attached to the wooden insert. Note that the doorknob and/or deadbolt lock do not contact the doorframe 10, and do not in any way inhibit the door 20 from freely swinging open/closed. The presence of the doorknob and/or deadbolt lock is solely for visual locating purposes.

In some embodiments, the amount of static contact force may not be adjustable without changing the spring 99. For example, a different mount approach, such retaining pins rather than threads 87, may be used to secure the mounting portion 82 in position.

Various embodiments of the door breaching system 5 described herein may be used for training of multiple breaching techniques. In a simple form, one or more detent systems 70 may be positioned in the upper zone 32 and/or lower zone 34, and the door breaching system 5 used for ram type breach training, by hitting the upper/lower strikeplates 28, and or the optional strikeplate 60. In another form, the wooden insert may be used, with the wooden insert being blasted by a shotgun or the like, and then the door 20 rammed open against the retention force of the detent system 70(s) in the upper zone 32 and/or lower zone 34. In other forms, the metal slider 40 may be used as part of a detent system 70, with or without additional detent system 70(s) in the upper zone 32 and/or lower zone 34, for training of a prying type breach.

The door breaching system 5 may be used free-standing using the optional support leg assemblies 50. Alternatively, the door breaching system 5 may be mounted in a breach training house without the optional support leg assemblies 50. In this regard, the door breaching system 5 described herein is particularly advantageous in that the detent system(s) 70 can be installed and removed from the doorframe/door 10/20 without accessing the outer perimeter 15 of the doorframe 10. Thus, the doorframe 10 can be mounted to the breach training house in a conventional fashion, and need not be removably mounted. The door breaching system(s) 5 described herein may also be used for training on other breaching techniques, such as explosive, cutting, and the like, provided the detent systems 70 are not damaged during the breaching event.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A door breach training system, comprising:
a doorframe;
a door pivotally mounted to the doorframe;
one or more detent systems interconnecting the door and doorframe and configured to releasably maintain the door closed so as to be pivotally aligned with the doorframe;
wherein the detent systems are configured to be reusable for a plurality of breaching events without replacing any components thereof; and
wherein the detent systems each comprise:
a first portion mounted to the doorframe;
a second portion mounted to the door and configured to releasably engage the first portion;
an elastic element that urges the first and second portions into engagement;
wherein the detent systems are configured to have an adjustable static contact force when the first and second portions are statically abutting, wherein the static contact force is infinitely adjustable.

2. The door breach training system of claim 1:
further comprising a pair of support leg assemblies configured to support the doorframe in a freestanding condition, each support leg assembly comprising at least two legs;
wherein the legs are connected to the doorframe so as to be deployable at a plurality of angles relative to the doorframe.

3. The door breach training system of claim 1, wherein the detent systems each include a piston having a tail that functions as a visual indicator to indicate that first and second portions are abutting.

4. The door breach training system of claim 1, wherein each second portion comprises:
a mounting portion having threads;
a piston slidably mounted to the mounting portion and having a tip;
an elastic element captured between the mounting portion and the tip;
wherein the elastic element biases the tip away from the mounting portion;
wherein the retention force is adjustable by tightening and/or loosening of the mounting portion via the threads.

5. The door breach training system of claim 4, wherein the tip of the piston is a removable tip.

6. The door breach training system of claim 5, wherein the elastic element is color coded.

7. The door breach training system of claim 1, wherein the first portion includes a bearing surface for engaging a tip of the second portion; and wherein the bearing surface forms a dimple.

8. The door breach training system of claim 1, wherein the detent systems are disposed vertically outside a central zone of the door.

9. The door breach training system of claim 1, wherein at least one of the detent systems includes a slider slidably mounted to the door and configured to slide toward and away from the doorframe.

10. The door breach training system of claim 1, wherein the first portion is both insertable into and removable from the doorframe without accessing the outer perimeter of the doorframe.

11. A door breach training system, comprising:
a doorframe having an outer perimeter and an inner perimeter;
a door pivotally mounted to the doorframe;
a plurality of detent systems interconnecting the door and doorframe and configured to releasably maintain the door closed so as to be pivotally aligned with the doorframe;
wherein the detent systems are configured to be reusable for a plurality of breaching events without replacing any components thereof;
wherein the detent systems each comprise:
a first portion mounted to the doorframe;
a second portion mounted to the door and configured to releasably engage the first portion;
an elastic element that urges the first and second portions into engagement;
wherein the first portion is both insertable into and removable from the doorframe without accessing the outer perimeter of the doorframe.

12. The door breach training system of claim 11, wherein the first and second portions are urged toward engagement by an elastic element forming a portion of the second portion.

13. The door breach training system of claim 11, wherein the first portion comprises a generally cylindrical body having a bearing face for engaging the second portion, and further comprising a retainer configured to releasably secure the first portion at least partially in the doorframe.

14. The door breach training system of claim 13, wherein the first portion is configured such that the body does not extend inwardly beyond the inner perimeter when the first portion is secured in the doorframe by the retainer.

15. The door breach training system of claim 13, wherein the first portion is configured such that the body extends inwardly beyond the inner perimeter when the first portion is secured in the doorframe by the retainer.

16. The door breach training system of claim 11:
wherein the plurality of detent systems comprises at least a first detent system disposed vertically outside a central zone of the door;
wherein the second portion of first detent system comprises:
a mounting portion releasably mounted to the door;
a piston slidably mounted to the mounting portion and having a tip disposed toward the doorframe;
an elastic element captured between the mounting portion and the tip;
wherein the elastic element biases the tip away from the mounting portion.

17. The door breach training system of claim 11:
wherein the plurality of detent systems comprises at least a first detent system disposed vertically in a central zone of the door;
wherein the first portion of the first detent system comprises:
a slider slidably mounted to the door;
a mounting portion releasably mounted to the door;
an elastic element captured between the mounting portion and the slider;
wherein the elastic element biases the slider away from the mounting portion and toward the doorframe;

18. The door breach training system of claim 17:
wherein the first portion of the first detent system further comprises a piston slidably mounted to the mounting portion and having a tip;
wherein the elastic element urges the tip against the slider to urge the slider toward the doorframe.

19. The door breach training system of claim 11:
further comprising support legs disposed on respective lateral sides of the doorframe and extending outward therefrom;
wherein the support legs are pivotally connected to the doorframe so as to be deployable at a plurality of angles relative to the doorframe.

20. The door breach training system of claim 19, wherein the support legs are removably connected to the doorframe.
